(19) United States
(12) Patent Application Publication
(10) Pub. No.: US 2025/0208003 A1
(43) Pub. Date: Jun. 26, 2025

(54) Rail Installation State Determination System

(71) Applicant: Daifuku Co., Ltd., Osaka-shi (JP)

(72) Inventors: Daisuke Ogawa, Hinocho (JP); Kazuhiro Saito, Hinocho (JP); Tadashi Nishikawa, Hinocho (JP); Hiroshi Sakata, Hinocho (JP); Daichi Tomida, Hinocho (JP); Kenshin Hashiguchi, Hinocho (JP)

(21) Appl. No.: 18/987,813

(22) Filed: Dec. 19, 2024

(30) Foreign Application Priority Data
Dec. 21, 2023 (JP) 2023-215760

(51) Int. Cl. G01M 99/00; G01H 1/00

(52) U.S. Cl. CPC G01M 99/005; G01H 1/00

(57) ABSTRACT

A rail installation state determination system includes a vibration database storing vibration data indicating a relationship between a position, a vibration, and a travel speed of a vehicle traveling along a rail, a preprocessor that performs preprocessing on the vibration data stored in the vibration database, and a determiner that determines the installation state of the rail based on the vibration data on which the preprocessing has been performed. A path includes a straight section and a curved section. The preprocessor performs a curved section exclusion process of excluding pieces of the vibration data obtained in the curved section from the vibration data stored in the vibration database.

### CROSS-REFERENCE TO RELATED APPLICATION

This application claims priority to Japanese Patent Application No. 2023-215760 filed Dec. 21, 2023, the disclosure of which is hereby incorporated by reference in its entirety.

### BACKGROUND OF THE INVENTION

### Field of the Invention

The present invention relates to a rail installation state determination system for determining the installation state of a rail.

### Description of Related Art

Japanese Unexamined Patent Application Publication No. 2011-221687 (JP No. 2011-221687) describes a travel cart system in which multiple travel carts each including a vibration sensor, a sound level sensor, and a current sensor travel along a travel path and transmit detection data including a detection position and a detection time to a ground controller.

In the travel cart system described in JP No. 2011-2216871, diagnosis data obtained from, for example, the vibration sensor, the sound level sensor, or the current sensor is analyzed for each travel cart by a travel cart analyzer, and analyzed for each railway trackside facility such as a traveling rail, a load port, or a buffer by an infrastructure analyzer. More specifically, the data obtained by the travel cart system in JP No. 2011-221687 includes data about vibrations and sound resulting from, for example, the shape of the rail or the traveling state of the vehicle, in addition to the installation state of the rail. Thus, the determination for the rail installation state may be performed using inappropriate data, possibly degrading the determination accuracy.

### SUMMARY OF THE INVENTION

One or more aspects are directed to a system that can determine the installation state of the rail easily with improved accuracy.

A rail installation state determination system according to an aspect of the disclosure is a rail installation state determination system for determining an installation state of a rail installed along a predetermined path in a vehicle traveling facility. The vehicle traveling facility includes the rail and a vehicle to travel along the rail. The rail installation state determination system includes a vibration database storing vibration data indicating a relationship between a position, a vibration, and a travel speed of the vehicle traveling along the rail, a preprocessor that performs preprocessing on the vibration data stored in the vibration database, and a determiner that determines the installation state of the rail based on the vibration data on which the preprocessing has been performed. The path includes a straight section in which the rail extends linearly in a plan view and a curved section in which the rail curves in a plan view. The preprocessor performs a curved section exclusion process of excluding pieces of the vibration data obtained in the curved section from the vibration data stored in the vibration database.

In this structure, the preprocessor performs the curved section exclusion process to avoid rail installation state determination performed based on the vibration data obtained in the curved section in which vibrations independent of the installation state of the rail are likely to occur. Thus, the determiner can easily determine the installation state of the rail with improved accuracy.

### BRIEF DESCRIPTION OF THE DRAWINGS

FIG. 1 is a diagram of a rail installation state determination system and a vehicle traveling facility.

FIG. 2 is a perspective view of a vehicle in FIG. 1.

FIG. 3 is a front view of the vehicle in FIG. 1.

FIG. 4 is a diagram of a junction area included in a path in FIG. 1.

FIG. 5 is a diagram of a branching area included in the path in FIG. 1.

FIG. 6 is a partially enlarged view of the path in FIG. 1.

FIG. 7 is a diagram of the rail installation state determination system in FIG. 1.

FIG. 8 is a diagram of a display screen of a display shown in FIG. 7.

FIG. 9 is a diagram of a display screen of the display shown in FIG. 7.

### DESCRIPTION OF THE INVENTION

A rail installation state determination system 100 according to one or more embodiments will now be described with reference to the drawings. The rail installation state determination system 100 described below has various technical features that are also applicable to a rail inspection method for the rail installation state determination system 100 and a rail inspection program for controlling the rail installation state determination system 100. Such a method and a program, as well as a storage medium storing the program (e.g., an optical disc or a flash memory) are also described herein.

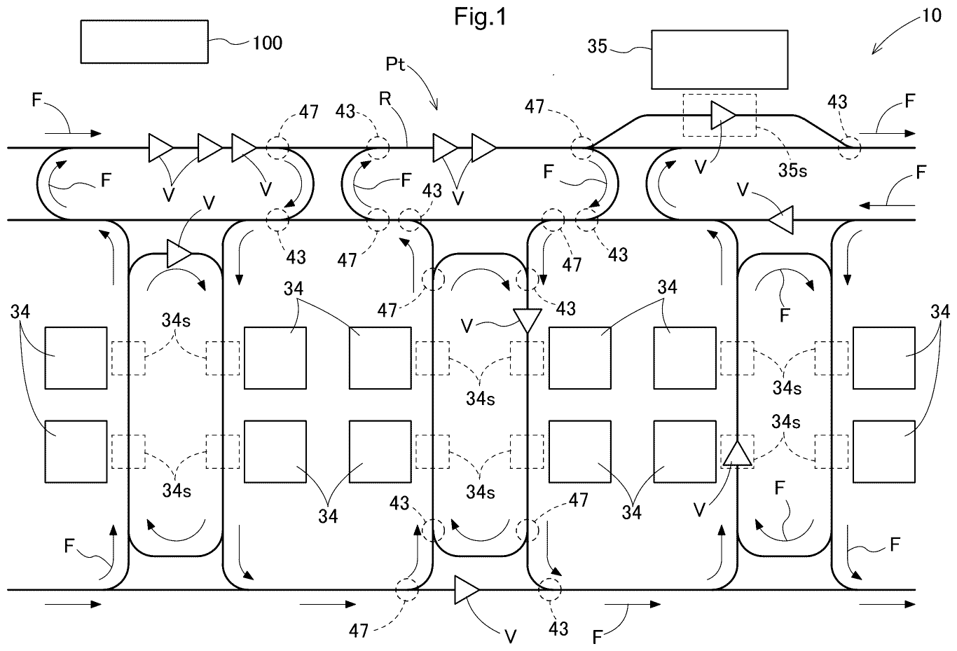

FIG. 1 is a diagram of an example vehicle traveling facility 10 to undergo determination performed by the rail installation state determination system 100 according to the present embodiment. The rail installation state determination system 100 determines the installation state of a rail R included in the vehicle traveling facility 10. The vehicle traveling facility 10 includes the rail R installed along a predetermined path Pt and vehicles V traveling along the rail R. Although the vehicle traveling facility 10 includes multiple vehicles V in the present embodiment, the vehicle traveling facility 10 may include a single vehicle V. Although the vehicle V is a transport vehicle that transports an article W, the vehicle V may transport a person, instead of the article W.

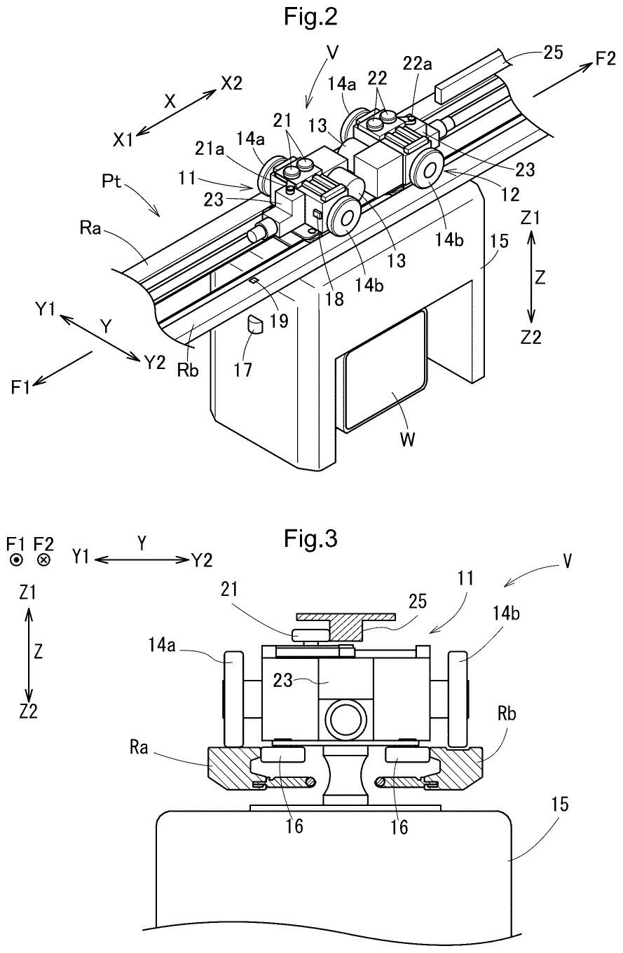

The direction along the path Pt is referred to as a travel direction X. The direction perpendicular to the travel direction X as viewed in a vertical direction Z (a horizontal direction perpendicular to the travel direction X in this example) is referred to as a width direction Y. As shown in FIG. 1, a forward direction F1 is defined for various parts of the path Pt. The direction opposite to the forward direction F1 is referred to as a reverse direction F2 (refer to FIG. 2). The vehicle V basically travels along the path Pt in the forward direction F1.

FIG. 2 is a perspective view of an example of the vehicle V. FIG. 3 is a front view of an example of the vehicle V. A side in the forward direction F1 along the path Pt is referred to as a downstream side X1, and a side in the reverse direction F2 along the path Pt is referred to as an upstream side X2. The travel direction X may also be referred to as the front-rear direction for the vehicle V. The downstream side X1 may also be referred to as a front side of the vehicle V. The upstream side X2 may also be referred to as a rear side of the vehicle V. One side in the width direction Y (the right as viewed in the forward direction F1 in this example) is referred to as a first side Y1 in the width direction, and the other side in the width direction Y (the left as viewed in the forward direction F1) is referred to as a second side Y2 in the width direction Y.

Each vehicle V travels along the path Pt to transport an article W. The article W is, for example, a front opening unified pod (FOUP) containing semiconductor wafers. The vehicle V is an automated guided vehicle. In the illustrated example, the vehicle V is a ceiling-hung transport vehicle. In the present embodiment, the path Pt allows the vehicle V to move between a sender of the article W and a destination of the article W in a circular manner while the vehicle V is traveling in the forward direction F1. The path Pt is physically defined by the rail R. The rail R is, for example, hung from the ceiling. In the present embodiment, the rail R includes a right rail portion Ra on which a right wheel 14a of the vehicle V rolls and a left rail portion Rb on which a left wheel 14b of the vehicle V rolls. The travel surface of the rail R faces in an upper direction Z1. In the illustrated example, the vehicle Vis a ceiling-hung transport vehicle, and the path Pt extends along the ceiling. However, the path Pt may extend on a floor surface.

The floor surface may be hung from the ceiling.

As shown in FIG. 2, each vehicle V includes a first traveler 11 as a traveler. The first traveler 11 includes the wheels (14a and 14b) rolling on the travel surface of the rail R, and a travel wheel driver 13 (e.g., an electric motor such as a servomotor) that rotates the wheels (14a and 14b). The wheels (14a and 14b) are driven by the travel wheel driver 13 to rotate, causing the first traveler 11 to travel along the rail R. In the present embodiment, each vehicle V further includes a second traveler 12 disposed on the upstream side X2 relative to the first traveler 11. The second traveler 12 has the same structure as the first traveler 11. The wheels (14a and 14b) are driven by the travel wheel driver 13 to rotate, causing the second traveler 12 to travel along the rail R. In the present embodiment, the wheels include the right wheel 14a and the left wheel 14b.

In the present embodiment, each vehicle V includes an auxiliary wheel 16 that comes in contact with and rolls on the side surface of the rail R. The auxiliary wheel 16 comes in contact with the rail R from at least one side in the width direction Y to roll on the rail R. In the example shown in FIG. 3, a pair of auxiliary wheels 16 are arranged in the width direction Y to come in contact with the rail R from both sides in the width direction Y.

The vehicle V includes a body 15 connected to the first traveler 11. The article W is accommodated in the body 15 and transported by the vehicle V. In the present embodiment, the body 15 is disposed in a lower direction Z2 from the first traveler 11 and supported by the first traveler 11.

In the present embodiment, the body 15 is connected to both the first traveler 11 and the second traveler 12. The body 15 is disposed in the lower direction Z2 relative to the first traveler 11 and the second traveler 12, and supported by the first traveler 11 and the second traveler 12.

As shown in FIG. 2, the vehicle V includes a collision avoidance sensor 17 that detects another vehicle V at a position on the downstream side X1 relative to the vehicle V. In response to the collision avoidance sensor 17 detecting another vehicle V, the vehicle V including the collision avoidance sensor 17 decelerates or stops to avoid collision with the other vehicle V.

As shown in FIG. 2, the path Pt includes multiple information holders 19, such as two-dimensional (2D) codes or radio-frequency (RF) tags. The information holders 19 are at the positions at which the vehicle Vis possibly stopped, such as an area before branching, an area after branching, an area before merging, and an area after merging. Each information holder 19 stores position information indicating the position of the information holder 19. The vehicle V includes a reader 18 that reads the position information held by the information holders 19, and identifies its current position based on the position information read by the reader 18.

The vehicle V identifies its current position based on, for example, the position information read by the reader 18 and a travel distance after the reader 18 reads the position information. The travel distance of the vehicle Vis measured using, for example, a rotary encoder. The vehicle V may identify its current position based on an output from a positioning device such as a global navigation satellite system (GNSS) receiver. The vehicle traveling facility 10 includes a control system (not shown) for controlling the multiple vehicles V. The control system obtains, from each vehicle V, the current position information about the vehicle V to determine a current position L of each of the multiple vehicles V.

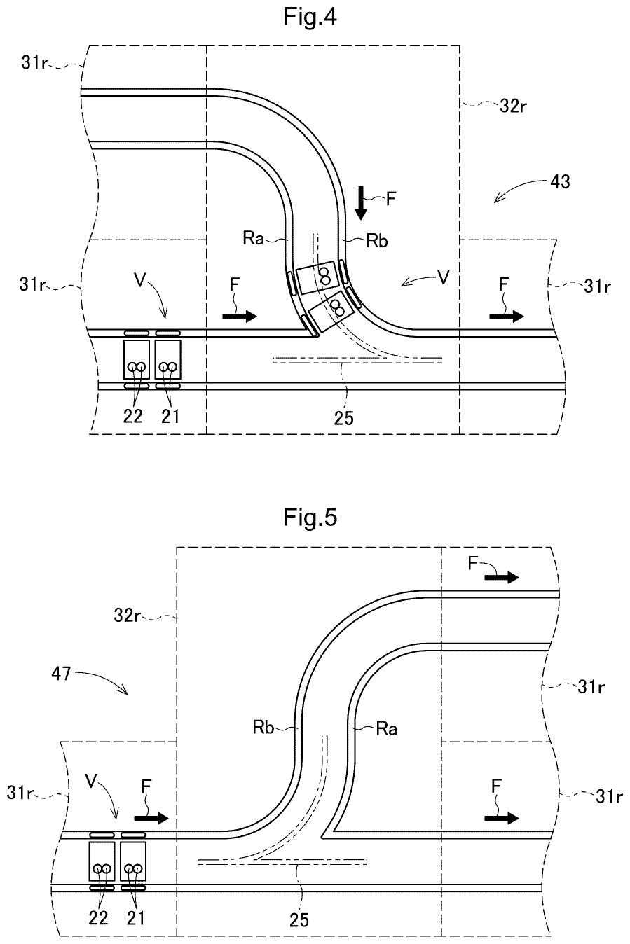

FIG. 4 is a diagram of an example of a junction area 43 included in the path Pt. FIG. 5 is a diagram of an example of a branching area 47 included in the path Pt. As shown in FIGS. 4 and 5, the path Pt includes guide rails 25 in some sections of the path Pt. In the present embodiment, the guide rails 25 are arranged in the upper direction Z1 relative to the rail R. In the present embodiment, each guide rail 25 is disposed between the right rail portion Ra and the left rail portion Rb in the width direction Y as viewed in the vertical direction.

Each vehicle V includes guided portions (21 and 22) that come in contact with either side surface of a guide rail 25 in the width direction Y to be guided by the guide rail 25, and guide drivers 23 (e.g., solenoids or electric motors) that move the guided portions in the width direction Y. The guide drivers 23 move the guided portions in the width direction Y by, for example, driving the guided portions alone in the width direction Y or by driving the guided portions in the width direction Y together with supports supporting the guided portions.

Referring back to FIG. 2, in the present embodiment, the first traveler 11 includes first guide wheels 21 that rotate (freely rotate in this example) about axes extending in the vertical direction Z as the guided portions. The guide driver 23 in the first traveler 11 moves the first guide wheels 21 in the width direction Y. In the example shown in FIG. 2, the first traveler 11 includes two first guide wheels 21 aligned in the travel direction X. The guide driver 23 moves the support supporting the two first guide wheels 21 in the width direction Y to move the two first guide wheels 21 in the width direction Y.

In the present embodiment, the second traveler 12 includes second guide wheels 22 that rotate (freely rotate in this example) about axes extending in the vertical direction Z as the guided portions. The guide driver 23 in the second traveler 12 moves the second guide wheels 22 in the width direction Y. In the example shown in FIG. 2, the second traveler 12 includes two second guide wheels 22 aligned in the travel direction X. The guide driver 23 moves the support supporting the two second guide wheels 22 in the width direction Y to move the two second guide wheels 22 in the width direction Y. The first guide wheels 21 and the second guide wheels 22 will be hereafter referred to as the guide wheels without being distinguished from each other when the features common to these guide wheels are described.

Each vehicle V includes movement detectors that detect movement of the guide wheels in the width direction Y. In the present embodiment, the first guide wheels 21 and the second guide wheels 22 are guide wheels, and a first movement detector 21a and a second movement detector 21b are the movement detectors. The vehicle V obtains detection results of the movement of the guide wheels in the width direction Y from the movement detectors to detect the guide wheels moving in the width direction Y or the positions of the guide wheels.

Multiple stations serving as destinations of the vehicles V are arranged on the path Pt. At a station, each vehicle V transfers an article W to or from an article support at the station. The operations of the vehicle V include traveling along the path Pt, receiving an article W from the article support at a station, and transferring an article W onto the article support at a station. The vehicle V travels to the station of a sender, receives an article W at the station of the sender, travels to the station of a destination, and transfers the article W at the station of the destination.

Examples of the above article support include a loading port in a processing device 34 that performs processing or sorting on the article W, a loading and unloading port in a storage device 35, and a storage shelf (not shown) that temporarily stores the articles W. The article support is disposed, for example, directly below the path Pt at each station.

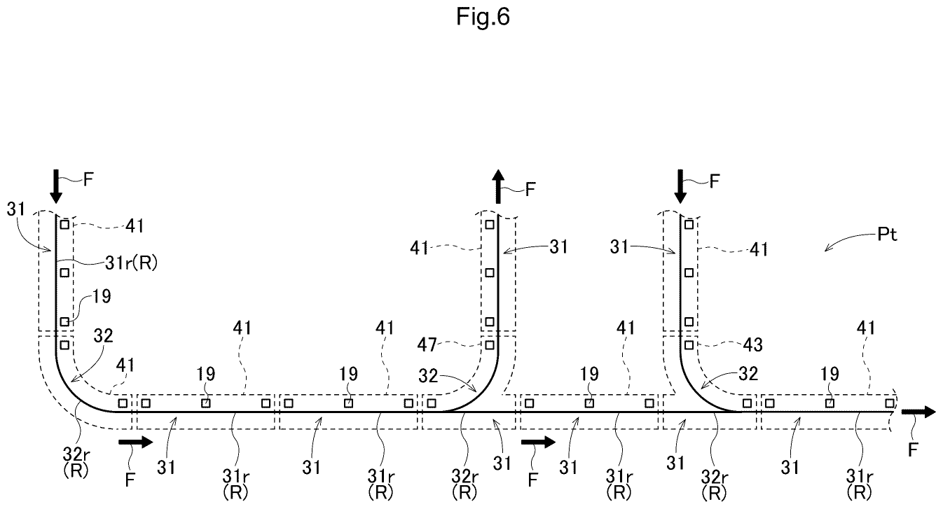

FIG. 6 is a diagram of an example of the path Pt. The path Pt includes a straight section 31 in which the rail R extends linearly in a plan view. The path Pt includes a curved section 32 in which the rail R curves in a plan view. The rail R includes multiple rail members with their ends connected to one another. The rail members may be members integrally formed from, for example, iron, steel, or concrete.

As shown in FIGS. 4 to 6, the rail R includes, in each curved section 32, a curved unit 32r including the rail members that are seamlessly continuous with each other. The rail members are seamlessly continuous with each other in the curved section 32 as described above. This reduces a vibration M in the vehicle V caused by an inappropriate installation state of the rail R in the curved section 32. The rail R includes straight units 31r including straight rail members that are seamlessly continuous with each other. The curved unit 32r may include both the curved rail member and the straight rail member. The straight section 31 includes one or more straight units 31r.

The path Pt includes the junction areas 43 in each of which multiple path sections merge into a single path section in each junction area 43. Each junction area 43 includes a section including one of the right rail portion Ra or the left rail portion Rb without including the other. The junction area 43 includes at least the curved section 32. In the illustrated example, the junction area 43 includes the straight section 31 and the curved section 32.

The path Pt includes the branching areas 47 in each of which a single path section branches into multiple path sections. Each branching area 47 includes a section including one of the right rail portion Ra or the left rail portion Rb without including the other. The branching area 47 includes at least the curved section 32. In the illustrated example, the branching area 47 includes the straight section 31 and the curved section 32.

The path Pt includes a normal area 41 that is an area other than the junction area 43 and the branching area 47. The normal area 41 includes both the right rail portion Ra and the left rail portion Rb. The normal area 41 includes at least one of the straight section 31 or the curved section 32.

In the illustrated example, the normal area 41 includes the straight section 31 and the curved section 32.

The path Pt includes multiple nodes at each of which the travel path branches or merges with each other and multiple links connecting a pair of nodes. In the present embodiment, the junction area 43 is a node at which the travel paths merge. In the example shown in FIG. 4, the node is a single curved unit 32r. In the present embodiment, the branching area 47 is a node at which the travel path branches. In the example shown in FIG. 5, the node is a single curved unit 32r. In the present embodiment, the normal area 41 is a link connecting a pair of nodes. The link includes at least one straight unit 31r or at least one curved unit 32r.

As shown in FIG. 6, the multiple nodes each include the information holders 19. The multiple links each include the information holders 19. The information holders 19 are arranged at, for example, both ends of the node or both ends of the link. The information holders 19 are arranged at, for example, an end of the curved unit 32r, a joint between the curved unit 32r and the straight unit 3 1r, an end of the straight unit 31r, a center of the straight unit 31r, and a center of the curved unit 32r.

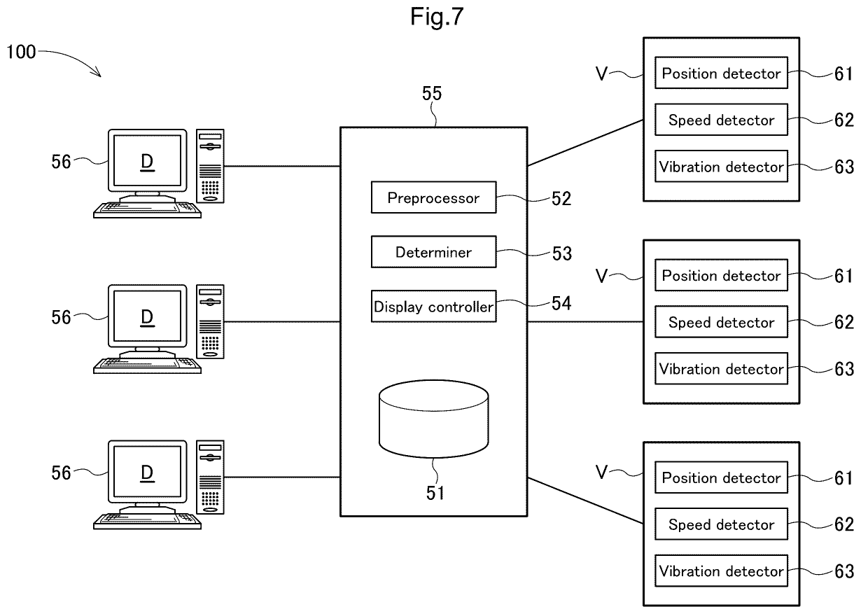

FIG. 7 is a diagram of an example of the rail installation state determination system 100. The rail installation state determination system 100 includes a vibration database 51 storing vibration data indicating the relationship between the position L, the vibration M, and a travel speed N of the vehicle V traveling along the rail R. The position L of the vehicle V may be an actually measured position, a predicted position, or a position indicated by any of the multiple curved units 32r and the multiple straight units 31r described above. Examples of the vibration M of the vehicle V include a vibration M in the travel direction X, a vibration M in the width direction Y, and a vibration M in the vertical direction Z. In the present embodiment, the travel speed N of the vehicle Vis an actually measured travel speed N, but may be derived from a target speed.

The rail installation state determination system 100 includes a preprocessor 52 that performs preprocessing S10 on the vibration data stored in the vibration database 51. The rail installation state determination system 100 includes a determiner 53 that determines the installation state of the rail R based on the vibration data on which the preprocessing S10 has been performed. In the present embodiment, the preprocessing S10 includes a curved section exclusion process S11, a deceleration exclusion process S13, an acceleration exclusion process S14, and a sorting process S15 (described below).

The preprocessor 52 performs a curved section exclusion process S11 of excluding pieces of the vibration data obtained in the curved section 32 from the vibration data stored in the vibration database 51. This structure can avoid determination of the installation state of the rail R based on the vibration data obtained in the curved section 32 in which the vibrations M independent of the installation state of the rail R are likely to occur.

In the present embodiment, the path Pt includes a first section and a second section. The first section includes the rail R extending with a curvature less than a predetermined first curvature in a plan view.

The second section includes the rail R extending with a curvature greater than or equal to the predetermined first curvature in a plan view.

In the present embodiment, the preprocessor 52 performs a first section exclusion process of excluding pieces of the vibration data obtained in the first section from the vibration data stored in the vibration database 51. In the present embodiment, the second section is the straight section 31, and the first section is the curved section 32. The first section exclusion process and the curved section exclusion process S11 are the same process.

The first curvature may be defined to allow the first section to be a section in which the vibration M of the vehicle V is likely to be greater when the rail R is installed in an appropriate state, the second section to be a section in which the vibration M of the vehicle Vis less likely to be greater when the rail R is installed in an appropriate state, or the second section to be a straight section 31 or a substantially straight section in which the rail R extends linearly in a plan view.

The preprocessor 52 performs a deceleration exclusion process S13 of excluding pieces of the vibration data obtained while the travel speed N is decreasing toward zero from the vibration data stored in the vibration database 51. Examples of the states in which the travel speed N is decreasing toward zero include a deceleration state in which the target speed for the deceleration is zero, a deceleration state in which the target speed for the deceleration is within a predetermined range of speeds (e.g., 0.5, 0.3, or 0.1 m/s or less) approximate to zero, and a state in which the travel speed N is within a predetermined range of times (e.g., 5, 1, or 0.5 seconds) before the deceleration.

The preprocessor 52 performs an acceleration exclusion process S14 of excluding pieces of the vibration data obtained while the travel speed N is increasing from zero from the vibration data stored in the vibration database 51. Examples of the states in which the travel speed N is increasing from zero include an acceleration state in which the acceleration starts at a zero acceleration, an acceleration state in which the acceleration starts at a speed within a predetermined range of speeds (e.g., 0.5, 0.3, or 0.1 m/s or less) approaching zero acceleration, and an acceleration state in which the travel speed N is zero is within a predetermined range of times (e.g., 5, 1, or 0.5 seconds) after the acceleration.

The preprocessor 52 further performs a sorting process S15 of sorting pieces of the vibration data remaining after the curved section exclusion process S11 as pieces of the vibration data obtained in the normal area 41, pieces of the vibration data obtained in the junction area 43, and pieces of the vibration data obtained in the branching area 47. Thus, pieces of the vibration data other than pieces of the vibration data obtained in the curved section 32 and excluded through the curved section exclusion process S11 can be sorted as pieces of the vibration data obtained in the normal area 41, pieces of the vibration data obtained in the junction area 43, and pieces of the vibration data obtained in the branching area 47. In the present embodiment, a determiner 53 determines the installation state of the rail R based on each set of the sorted pieces of the vibration data. This structure facilitates determination reflecting the effects of any different vibrations M caused by the installation state of the rail R in the normal area 41, the junction area 43, and the branching area 47. For example, the vehicle V traveling on one wheel in some sections in the junction area 43 and the branching area 47 in the straight section 31 can easily have a vibration M different from the vibration M in the straight section 31 in the normal area 41. In the present embodiment, the sorting process S15 is performed on pieces of the vibration data remaining after the curved section exclusion process S11, the deceleration exclusion process S13, and the acceleration exclusion process S14 are performed.

The determiner 53 performs determination through machine learning using, for example, an autoencoder, a convolutional neural network (CNN), a recurrent neural network (RNN), or a decision tree. The determiner 53 may use time-series analysis with, for example, an auto regressive integrated moving average (ARIMA) model or a Trigonometric Box-Cox transform, ARMA errors, Trend and Seasonal components (TBATS) model to perform the determination. The determiner 53 may determine the installation state of the rail R based on the comparison between the normal data indicating the relationship between the vibration M and the travel speed N at the position of an appropriate installation state of the rail R and the vibration data indicating the relationship between the position L, the vibration M, and the travel speed N of the vehicle V traveling on the rail R. The determiner 53 may determine the installation state of the rail R based on the comparison between the abnormal data indicating the relationship between the vibration M and the travel speed N at the position of an inappropriate installation state of the rail R and the vibration data indicating the relationship between the position L, the vibration M, and the travel speed N of the vehicle V traveling on the rail R. The installation state of the rail R may be determined using a determination threshold. Examples of the determination of the installation state of the rail R include determining the normality of the installation state of the rail R, identifying the position of an appropriate installation state of the rail R, and identifying the position of an inappropriate installation state of the rail R.

The determiner 53 performs determination on the vibration data on which the preprocessing S10 has been performed. The determiner 53 determines the installation state of the rail R based on a waveform Ma of the vibration M indicated by the vibration data. The determiner 53 performs determination on the vibration data on which the preprocessing S10 has been performed, and determines the position of the rail R having a step greater than or equal to a predetermined height to be the position of an inappropriate installation state of the rail R. Examples of the waveform Ma of the vibration M include the shape of the vibration M, an amplitude Mb of the vibration M, an average value of the vibration M, and the frequency of the vibration M. Examples of the amplitude Mb of the vibration M include a difference between a maximum value and a minimum value, a difference between the maximum value and the average value, and a difference between the minimum value and the average value. Examples of the step on the rail R include, for example, a step on the rolling surface of the wheel on the rail R, a step on the upper surface of the rail R, and a step on the side surface of the rail R.

The rail installation state determination system 100 includes a server 55. The rail installation state determination system 100 includes displays 56. The rail installation state determination system 100 includes a display controller 54 for controlling the displays 56. In the present embodiment, the server 55 includes the vibration database 51, the preprocessor 52, the determiner 53, and the display controller 54. Multiple clients included in the rail installation state determination system 100 each include the corresponding display 56.

Although the server 55 is installed outside the vehicle V in the present embodiment, the server 55 may be installed inside the vehicle V. The server 55 may include multiple control devices and arithmetic devices, some of which may be installed inside the vehicle V and others may be installed outside the vehicle V. The displays 56 may be installed on or outside the vehicle V. The rail installation state determination system 100 may include a single display 56 alone.

The rail installation state determination system 100 includes a position detector 61 that detects the position L. The rail installation state determination system 100 includes a speed detector 62 that detects the travel speed N. The rail installation state determination system 100 includes a vibration detector 63 that detects the vibration M. Examples of the position detector 61 include the above reader 18, and a position detection device including a global positioning system (GPS), a real time kinematic (RTK), and processing of images captured with an imaging device. Examples of the speed detector 62 include a device that calculates the travel speed N based on the rotational speed of the wheels (14a and 14b) of the vehicle V, a device that calculates the travel speed N based on the position L and a travel time T, and a device that detects the travel speed N based on a video captured with an imaging device. Examples of the vibration detector 63 include a vibration meter that detects vibrations in an article storage in the body 15, a vibration meter that detects vibrations in the traveler of the vehicle V (the first traveler 11 and the second traveler 12), and a vibration meter that detects vibrations in the rail R.

The vibration detector 63 detects the waveform Ma. The vibration detector 63 detects at least one or two of the vibration M in the travel direction X, the vibration M in the width direction Y, or the vibration M in the vertical direction Z. In the present embodiment, the vibration detector 63 detects at least the vibration M in the vertical direction Z. In the present embodiment, the position detector 61, the speed detector 62, and the vibration detector 63 are installed on each of the multiple vehicles V, but may be installed on a single vehicle V.

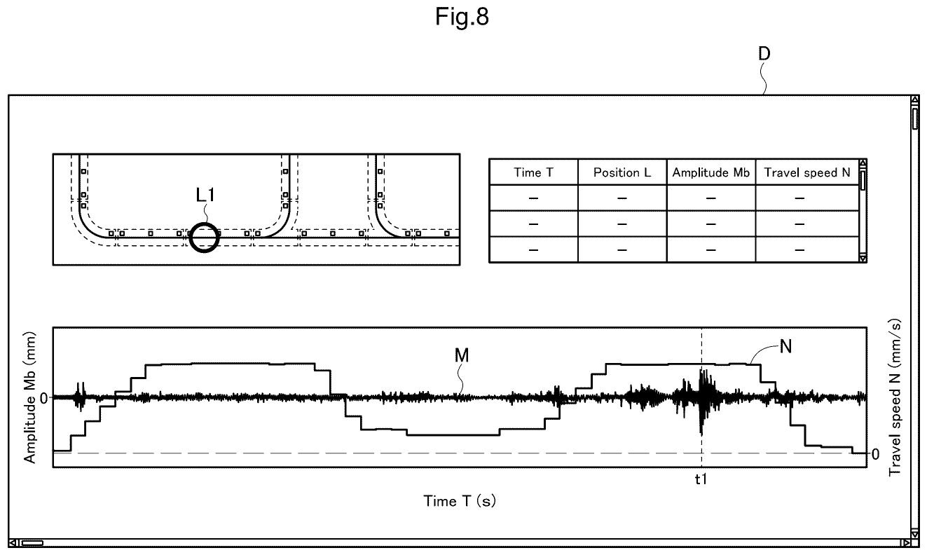

The display controller 54 displays a map of the path Pt with the position L of the vehicle V on a display screen D of the display 56. The display controller 54 simultaneously displays the vibration M of the vehicle V including the vibration detector 63 on the display screen D of each display 56 and the map of the path Pt showing the position L of the vehicle V at the time the vibration M is detected. FIG. 8 is a diagram of an example of the display screen D on which the vibration M and the map of the path Pt indicating the position L appear at the same time. In the present embodiment, the vibration M is displayed as the waveform Ma with the travel time T on the horizontal axis and the degree of displacement on the vertical axis. In the illustrated example, the position LI of the vehicle V corresponding to a travel time to is displayed on the map of the path Pt.

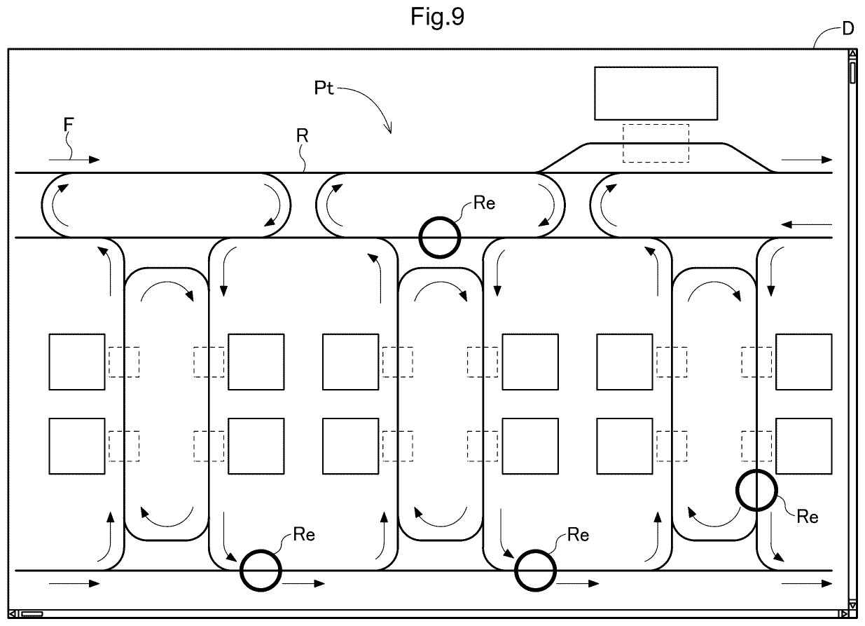

The display controller 54 displays a map of the path Pt showing a determination result Re obtained by the determiner 53 on the display screen D of each display 56. FIG. 9 is a diagram of an example of the display screen D showing the determination result Re obtained by the determiner 53 on the map of the path Pt. Examples of the determination result Re obtained by the determiner 53 and displayed on the map of the path Pt include a position at which the installation state of the rail R is determined to be inappropriate, a position at which the installation state of the rail R is determined to be appropriate,, and the degree of normality of the installation state of the rail R. In the example shown in FIG. 9, the position at which the installation state of the rail R is determined to be inappropriate is indicated by a bold circle on the map of the path Pt. The map of the path Pt shows multiple determination results Re obtained by the determiner 53. Examples of the map of the path Pt showing the determination results Re include an overall map of the path Pt, a map of at least a half of the entire path Pt, and a map of at least a quarter of the entire path Pt.

In the rail installation state determination system 100 according to the present embodiment, the curved section exclusion process S11 is performed to easily identify the position of an inappropriate installation state of the rail R in at least the straight section 31. The position of an inappropriate installation state of the rail R in the curved section 32 may often affect the vibration data obtained in the adjacent straight sections 31. Thus, the position of an inappropriate installation state of the rail R in the curved section 32 may also be identified easily. In the present embodiment, the vibration data can be obtained in the straight section 31 in the normal area 41 through the sorting process S15. This allows more vibration data indicating the normal installation state of the rail R to be obtained. For example, the obtained data may be used for machine learning or setting of thresholds to easily increase the accuracy of determination. In the present embodiment, the vibration data includes, in addition to the vibration M in the vertical direction Z, the vibration M in the travel direction X and the vibration M in the width direction Y. Thus, any positional deviations of the rail R in the width direction Y may be easily identified, in addition to a step on the rail R.

A rail installation state determination system 100 according to other embodiments will now be described.

(1) In the above embodiment, the preprocessing S10 includes the curved section exclusion process S11. In some embodiments, the preprocessing S10 may include either the deceleration exclusion process S13 or the acceleration exclusion process S14, or both the deceleration exclusion process S13 and the acceleration exclusion process S14, without including the curved section exclusion process S11. For example, the preprocessing S10 may include a first section exclusion process in place of the curved section exclusion process S11. For example, a second section may include a straight section 31 and a curved section 32 with a first curvature or greater. The first section exclusion process may differ from the curved section exclusion process S11. For example, the second section may be a curved section without including the straight section 31. For example, the preprocessing S10 may include, in place of the curved section exclusion process S11, a straight section extraction process S21 of extracting the vibration data obtained in the straight section 31 from the vibration data stored in the vibration database 51.

(2) In the above embodiment, the preprocessor 52 performs the sorting process S15 of sorting the vibration data obtained in the normal area 41, the vibration data obtained in the junction area 43, and the vibration data obtained in the branching area 47. In some embodiments, for example, the sorting process S15 may sort pieces of the vibration data obtained in the normal area 41 from pieces of the vibration data obtained in the junction area 43 and the branching area 47. For example, the sorting process S15 may sort pieces of the vibration data obtained in the normal area 41 from pieces of the vibration data obtained in the junction area 43. For example, the sorting process S15 may sort pieces of the vibration data obtained in the normal area 41 from pieces of the vibration data obtained in the branching area 47. For example, the preprocessor 52 may not perform the sorting process S15.

(3) In the above embodiment, the preprocessing S10 includes the deceleration exclusion process S13 and the acceleration exclusion process S14. In some embodiments, for example, the preprocessing S10 may not include the deceleration exclusion process S13. For example, the preprocessor 52 may not include the acceleration exclusion process S14.

(4) In the above embodiment, the sorting process S15 is performed on pieces of the vibration data remaining after the curved section exclusion process S11, the deceleration exclusion process S13, and the acceleration exclusion process S14 are performed. In some embodiments, for example, the curved section exclusion process S11, the deceleration exclusion process S13, the acceleration exclusion process S14, and the sorting process S15 may be performed in any other order.

(5) In the above embodiment, the rail installation state determination system 100 includes the server 55 and the multiple clients including the displays 56. In some embodiments, the rail installation state determination system 100 may be, for example, a stand-alone system. For example, the rail installation state determination system 100 may include a single display 56 alone.

(6) In the above embodiment, the determiner 53 determines the installation state of the rail R based on the vibration data obtained in the straight section 31. In some embodiments, for example, the determiner 53 may determine the installation state of the rail R based on the vibration data obtained in the straight section 31 and the vibration data obtained in the second section. For example, in the preprocessing S10, the vibration data may be sorted as pieces of the vibration data obtained in the straight section 31 and the vibration data obtained in the second section. The determiner 53 may then determine the installation state of the rail R based on each set of the sorted pieces of the vibration data.

(7) The structure described in each of the above embodiments may be combined with any other structures described in the other embodiments unless any contradiction arises. This also applies to combinations of the embodiments described as other embodiments. For other structures as well, the embodiments described herein are merely illustrative in all aspects. Thus, the embodiments described herein may be modified variously as appropriate without departing from the spirit and scope of the disclosure.

A rail installation state determination system according to one or more embodiments of the disclosure will now be described.

In one aspect, a rail installation state determination system is a rail installation state determination system for determining an installation state of a rail installed along a predetermined path in a vehicle traveling facility. The vehicle traveling facility includes the rail and a vehicle to travel along the rail. The rail installation state determination system includes a vibration database storing vibration data indicating a relationship between a position, a vibration, and a travel speed of the vehicle traveling along the rail, a preprocessor that performs preprocessing on the vibration data stored in the vibration database, and a determiner that determines the installation state of the rail based on the vibration data on which the preprocessing has been performed. The path includes a straight section in which the rail extends linearly in a plan view and a curved section in which the rail curves in a plan view. The preprocessor performs a curved section exclusion process of excluding pieces of the vibration data obtained in the curved section from the vibration data stored in the vibration database.

In this structure, the preprocessor performs the curved section exclusion process to avoid rail installation state determination performed based on the vibration data obtained in the curved section in which vibrations independent of the installation state of the rail are likely to occur. Thus, the determiner can easily determine the installation state of the rail with improved accuracy.

In one aspect, the path includes a junction area in which a plurality of path sections merge into a single path section, a branching area in which a single path section branches into a plurality of path sections, and a normal area being an area other than the junction area and the branching area. The preprocessor further performs a sorting process of sorting pieces of the vibration data remaining after the curved section exclusion process as pieces of the vibration data obtained in the normal area and pieces of the vibration data obtained in the junction area or the branching area.

This structure allows the determiner to determine the installation state of the rails based on the vibration data obtained in the normal area and the vibration data obtained in the junction area or the branching area. This structure facilitates determination reflecting the effects of any different vibrations caused by the installation state of the rail in the normal area, the junction area, and the branching area. Thus, the determiner can easily determine the installation state of the rail with improved accuracy.

In one aspect, the preprocessor performs a deceleration exclusion process of excluding pieces of the vibration data obtained while the travel speed is decreasing toward zero from the vibration data stored in the vibration database.

In this structure, the preprocessor performs the deceleration exclusion process to avoid rail installation state determination performed based on the vibration data including vibrations caused by stopping and decelerating the vehicle. Thus, the determiner can easily determine the installation state of the rail with improved accuracy.

In one aspect, the preprocessor performs an acceleration exclusion process of excluding pieces of the vibration data obtained while the travel speed is increasing from zero from the vibration data stored in the vibration database.

In this structure, the preprocessor performs the acceleration exclusion process to avoid rail installation state determination performed based on the vibration data including vibrations caused by starting and accelerating the vehicle. Thus, the determiner can easily determine the installation state of the rail with improved accuracy.

The rail installation state determination system according to one or more embodiments of the disclosure may produce at least one of the advantageous effects described above.

What is claimed is:

1. A rail installation state determination system for determining an installation state of a rail installed along a predetermined path in a vehicle traveling facility, the vehicle traveling facility comprising the rail and a vehicle to travel along the rail, the rail installation state determination system comprising:
a vibration database storing vibration data indicating a relationship between a position, a vibration, and a travel speed of the vehicle traveling along the rail;
a preprocessor configured to perform preprocessing on the vibration data stored in the vibration database; and
a determiner configured to determine the installation state of the rail based on the vibration data on which the preprocessing has been performed,
wherein the path comprises a straight section in which the rail extends linearly in a plan view and a curved section in which the rail curves in a plan view, and
wherein the preprocessor is configured to perform a curved section exclusion process of excluding pieces of the vibration data obtained in the curved section from the vibration data stored in the vibration database.

2. The rail installation state determination system according to claim 1, wherein:
the path comprises a junction area in which a plurality of path sections merge into a single path section, a branching area in which a single path section branches into a plurality of path sections, and a normal area is an area other than the junction area and the branching area, and
the preprocessor further performs a sorting process of sorting pieces of the vibration data remaining after the curved section exclusion process as pieces of the vibration data obtained in the normal area and pieces of the vibration data obtained in the junction area or the branching area.

3. The rail installation state determination system according to claim 1, wherein:
the preprocessor performs a deceleration exclusion process of excluding pieces of the vibration data obtained while the travel speed is decreasing toward zero from the vibration data stored in the vibration database.

4. The rail installation state determination system according to claim 1, wherein:
the preprocessor performs an acceleration exclusion process of excluding pieces of the vibration data obtained while the travel speed is increasing from zero from the vibration data stored in the vibration database.
